(19) United States
(12) Patent Application Publication
(10) Pub. No.: US 2012/0174636 A1
(43) Pub. Date: Jul. 12, 2012

(54) SPIN-AND-CLICK COMBINATION DIAL LOCK ASSEMBLY

(75) Inventors: Christopher Rohde, West Allis, WI (US); Christopher Irgens, Brookfield, WI (US); Frank Scott, Milwaukee, WI (US)

(73) Assignee: Wordlock, Inc., Santa Clara, CA (US)

(21) Appl. No.: 13/342,842

(22) Filed: Jan. 3, 2012

Related U.S. Application Data
(60) Provisional application No. 61/429,365, filed on Jan. 3, 2011.

(51) Int. Cl. E05B 37/06; E05B 37/02; E05B 37/00

(52) U.S. Cl. 70/315; 70/332; 70/266

(57) ABSTRACT

A resettable, combination dial lock assembly has a housing, a shackle, and a dial with indicia thereon. A subset of the indicia defines an unlocking combination. The dial is rotatable relative to the housing to positions corresponding to each of the indica subset. A selector is coupled to the dial. Combination members rotate upon rotation of the dial and are each associated with a respective one of the subset of indicia comprising the combination. Rotary members are coupled to the combination members, wherein rotation of the combination members causes rotation of the rotary members. The rotary members and combination members allow entry of the combination by rotating the dial in any direction and independent of a number of rotations made by the dial for activation of the selector to select each of the indicia comprising the combination to unlock the lock assembly.

### CROSS REFERENCE TO RELATED APPLICATIONS

This non-provisional patent application hereby claims priority to Provisional Patent Application No. 61/429,365, titled SPIN-AND-CLICK COMBINATION DIAL LOCK ASSEMBLY, filed Jan. 3, 2011, which is hereby by incorporated herein in its entirety by reference thereto.

### TECHNICAL FIELD

The present technology is directed to combination locks, and more particularly to dial lock assemblies and methods of making the same.

### BACKGROUND

Conventional combination dial or rotary locks have a rotating dial that displays a range of numbers. To enter a combination, a user can rotate the dial in opposing directions (e.g., right, left, right) and align each number of the combination with an indicator (e.g., an indent). Once the combination is entered, the lock moves to an unlocked configuration such that the lock's shackle can move between open and closed positions.

Most dial locks have internal components rotationally dependent upon one another to establish the proper combination to open the lock. For example, the locks typically require a user to rotate the dial at least 2 full rotations to the left (counterclockwise) to prepare the lock for the user to input the combination. Then the user must rotate the dial to right (clockwise) to the first number of the three-number combination. The user must then rotate the dial one full revolution to the left, past the first number of the combination to the second number of the combination. Then the user must rotate the dial to the right from the second number directly to the third number of the combination (less than one full revolution), without passing and going back to the third number. After successfully completing the rotation of the dial in the right, left, right pattern to the designated combination, the user can then open the lock. If the user makes an error while inputting the combination, the user must start over and try to input the proper combination in the correct right, left, right pattern.

The conventional dial lock assemblies have three-digit combinations because of the right, left, right rotational requirements to input the proper combination. The combination for the right, left, right dial lock is established during manufacturing, and once the lock is assembled, the combination is not resettable. There is a need for an improved dial lock that is not directionally dependent for inputting the combination, that can have a combination with more than three digits or characters, and that may be resettable.

### SUMMARY

Aspects of the present invention is directed to combination dial lock assemblies that overcome drawbacks experienced in the prior art and provide additional benefits. In accordance with aspects of an embodiment, a combination dial lock assembly has a housing, a shackle moveable between locked, closed and unlocked, open positions, and a dial rotatably coupled to the housing. The dial has a face portion and a drive portion, and indicia are provided on the face portion or the housing. A subset of the indicia defines a combination to allow the shackle to move from the locked, closed position to the unlocked, open position. The dial is rotatable to positions corresponding to each of the subset of the indicia comprising the combination. A selector is coupled to the dial and is moveable to a select position. A plurality of combination members are connected to the drive portion of the dial and are rotatable upon rotation of the dial. Each combination member is associated with a respective one of the subset of indicia comprising the combination. One combination member is disengageable from the drive portion upon moving the selector to the select position, wherein the one combination member is stationary relative to the housing while at least a second combination member is rotatable with the dial independent of the stationary one combination member.

A plurality of rotary members is coupled to the combination members, wherein rotation of the combination members causes rotation of the rotary members. The rotary members are positionable in an unlocked configuration upon rotation of the dial, independent of a direction of rotation, to each indicia comprising the combination and upon activation of the selector at each indicia comprising the combination. A combination change mechanism is movable between set and changes positions. The combination change mechanism is activatable to manipulate the rotary members or the combination members when in the change position to change the combination from a first combination to a second combination.

In aspects of embodiments disclosed herein, the combination members can comprise a plurality of combination discs. The combination members can comprise a stack of coaxially aligned combination discs. The combination members can comprise a stack of nested combination discs. The rotary members can comprising a second stack of change wheels coaxially aligned on a second axis of rotation spaced apart from the combination members. The rotary members can comprise a stack of coaxially aligned of change wheels. The combination members can comprise a plurality of combination discs having first gear teeth thereon, and the rotary members can comprise a plurality of change wheels having second gear teeth thereon that mate with the first gear teeth, whereby rotation of the combination discs cause rotation of the change wheels.

In additional aspects of the embodiments, the rotary members can comprise a plurality of change wheels and change hubs, wherein the change wheels are rotatable relative to the change hubs when the combination change mechanism is in the change position. The change wheels can be rotatable with the change hubs when the combination change mechanism is in the set position and the change wheels can be rotatable relative to the change hubs when the combination change mechanism is in the change position. Each change hub can be associated with a respective one of the change wheels. Each of the change hubs can have a notch therein positioned relative to the change wheel and that align with notches in the other change hubs upon entry of the combination by activation of the selector at each indicia comprising the combination.

The lock assembly can include a lever assembly that interconnects the shackle and the rotary members. The lever assembly prevents the shackle from moving away from the locked, closed position prior the rotary members being positioned in the unlocked configuration. The lock assembly can include a change selector connected to the combination change mechanism and being movable to move the combination change mechanism between the set and change positions. The selector can be connected to the dial and be slidable relative to the dial to the select position to disengage the combination member when the dial has been rotated for selection one of the indicia.

In another embodiment a resettable, combination dial lock assembly comprises a housing, a shackle moveable locked, closed and unlocked, open positions, and a dial connected to the housing. The dial or the housing has indicia thereon, and a subset of the indicia defines a combination to unlock the lock assembly. The dial is rotatable to positions corresponding to each of the subset of the indicia. A selector is coupled to the dial, and combination members that rotate upon rotation of the dial are associated with a respective one of the subset of indicia comprising the combination. Rotary members are coupled to the combination members, wherein rotation of the combination members causes rotation of the rotary members. The rotary members and combination members are configured to allow the dial to be rotated in any direction and independent of a number of rotations made by the dial for activation of the selector to select each of the indicia comprising the combination to unlock the lock assembly.

Another aspect of the disclosed embodiments includes a method of unlocking a combination dial lock assembly. The method includes engaging a dial of the combination dial lock assembly, rotating the dial in a first direction relative to the housing to a first position corresponding to a first entry of the subset of the indicia, selecting with the selector the first entry when the dial is in the first position, rotating the dial relative to the housing to a second position corresponding to a second entry of the subset of the indicia, and selecting with the selector the second entry when the dial is in the second position. The dial is rotatable in either direction to define a second direction to the second entry independent of the first direction and is rotatable directly to the second entry or after one or more full revolutions of the dial relative to the housing to select the second entry. The method further includes rotating the dial relative to the housing to a third position corresponding to a third entry of the subset of the indicia, and selecting with the selector the third entry when the dial is in the third position. The dial is rotatable in either direction to the third entry independent of the first and second directions and being rotatable directly to the third entry or after one or more full revolutions of the dial relative to the housing to select the third entry. The method further includes moving the shackle from the locked, closed position to the unlocked, open position after sequentially selecting the first, second and third entries.

Aspects of the disclosed embodiments can include the method wherein the dial is rotatable in either direction to define a third direction to the third entry, rotating the dial relative to the housing to a fourth position corresponding to a fourth entry of the subset of the indicia, selecting with the selector the fourth entry when the dial is in the fourth position, wherein the dial is rotatable in either direction to the fourth entry independent of the first, second, and third directions and being rotatable directly to the fourth entry or after one or more full revolutions of the dial relative to the housing to select the fourth entry. The method can include moving the shackle from the locked, closed position to the unlocked, open position after sequentially selecting the first, second, third, and fourth entries. Aspects of the disclosed embodiments can include the method wherein the first and second directions are the same direction. The method can include activating a change selector and changing the combination to a second combination different from the first combination.

In another embodiment a resettable, combination dial lock assembly, comprises a housing, a resettable locking mechanism in the housing, and a shackle connected to the locking mechanism. The shackle is being moveable relative to the housing between closed and open positions. A dial rotatably is coupled to locking mechanism. The dial has indicia thereon, and a subset of the indicia defines a combination to unlock the locking mechanism. The dial is rotatable to positions corresponding to each of the indicia comprising the combination. The locking mechanism is moveable from a locked configuration to an unlocked configuration upon rotation of the dial in either direction to the positions corresponding to the combination. In the locked configuration the locking mechanism retains the shackle in the closed position, and in the unlocked configuration the locking mechanism is disengagable from the shackle and allows the shackle to move to the open position. The locking mechanism comprises a combination-disc assembly having a drive shaft connected to the dial and being rotatable with the dial. Combination discs are coupled to the drive shaft and are engagable and rotatable with drive shaft upon rotation of the dial. Each combination disc is associated with a respective one of the indicia comprising the combination. A first combination disc is movable relative to the drive shaft between engaged and disengaged positions. The first combination disc in the engaged position is rotatable with the dial and drive shaft. The first combination disc in the disengaged position is disengaged from a second combination disc or from the drive shaft and is restricted from rotation relative to the housing while the dial and the drive shaft are rotated.

A release lever is in the housing and is coupled to the shackle. The release lever has engaged and released positions, and the release lever can be in the engaged position when the shackle is in the closed position. The shackle is restricted from moving to the open position when the release lever is in the engaged position. The release lever is moveable to the release position upon entry of the combination by a user, wherein the release lever in the released position allows the shackle to move to the open position. The combination change assembly has a plurality of rotary members in the housing, and the rotary members are in engagement with the combination discs. Rotation of the combination discs causes rotation of the rotary members relative to the release lever. Each rotary member is associated with a digit of the combination and each rotary member has a receiver alignable with a portion of the release lever when the associated digit of the combination is entered. The rotary members block the release lever from moving from the engaged position to the released position when one or more of the receivers are out of alignment with the portion of the release lever. The rotary members allow the release lever to move from the engaged position to the released position when all of the receivers are in alignment with the portion of the release lever. A selection assembly can be coupled to the dial and to the combination disc assembly. The selection assembly is activatable to move at least one combination discs to the disengaged position when the dial has been moved to the digit of the combination associated with the at least one combination disc independent of a rotation direction of the dial or a number of rotations made by the dial to move to the digit.

### BRIEF DESCRIPTION OF THE DRAWINGS

FIG. 1 is an isometric view of an embodiment of the combination dial lock assembly in accordance with an embodiment of the present disclosure.

FIG. 2 is a schematic view of inner lock components of a dial lock assembly of an embodiment of the present disclosure.

FIG. 3 is a schematic, partially cut away isometric view of the internal lock components of the dial lock assembly of FIG. 2.

FIGS. 4A-4D are schematic isometric views of the four combination discs showing dial drive points/notches and outer gear teeth for driving combination change wheels and lever drop assembly.

FIG. 5 is a schematic isometric and cross-sectional view of the combination disc assemblies.

FIGS. 6A-6D are a schematic, partially cut away isometric views and side elevation views of combination change wheels and a drop assembly of the lock assembly.

FIG. 7 is a schematic partially cut-away isometric view of the combination change wheels and drop assembly of FIG. 6A.

FIGS. 8A and 8B are schematic isometric views of combination change wheels and a change hub.

FIG. 9 is a schematic, partially cut away, isometric view of lever drop fingers that constrain the combination change wheels of the lock assembly.

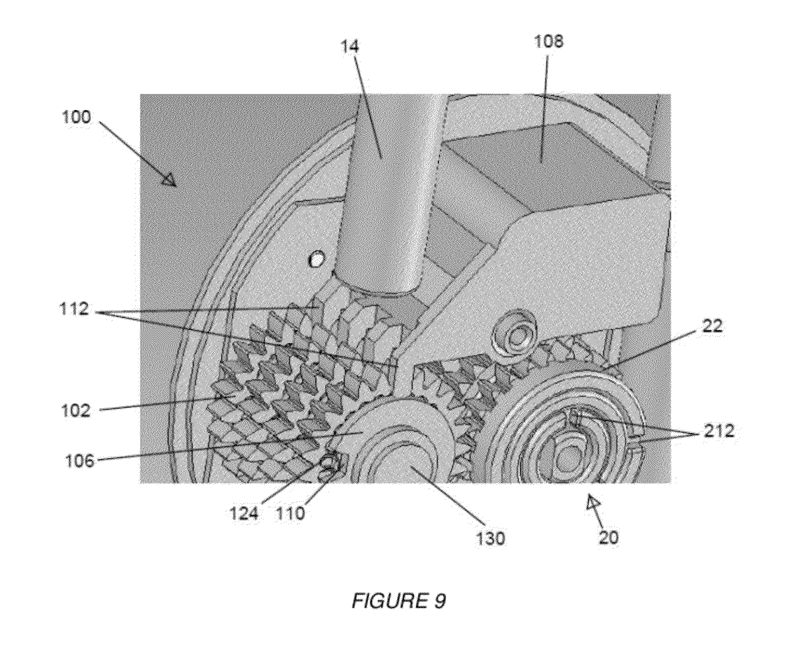

FIGS. 10A-10D are schematic, partially cut away, isometric views of a change cam feature of the lock assembly.

FIG. 11 is a schematic, partially cut away, isometric view of a friction spring feature of the lock assembly.

FIG. 12 is a schematic isometric view of the lock assembly with a slide button.

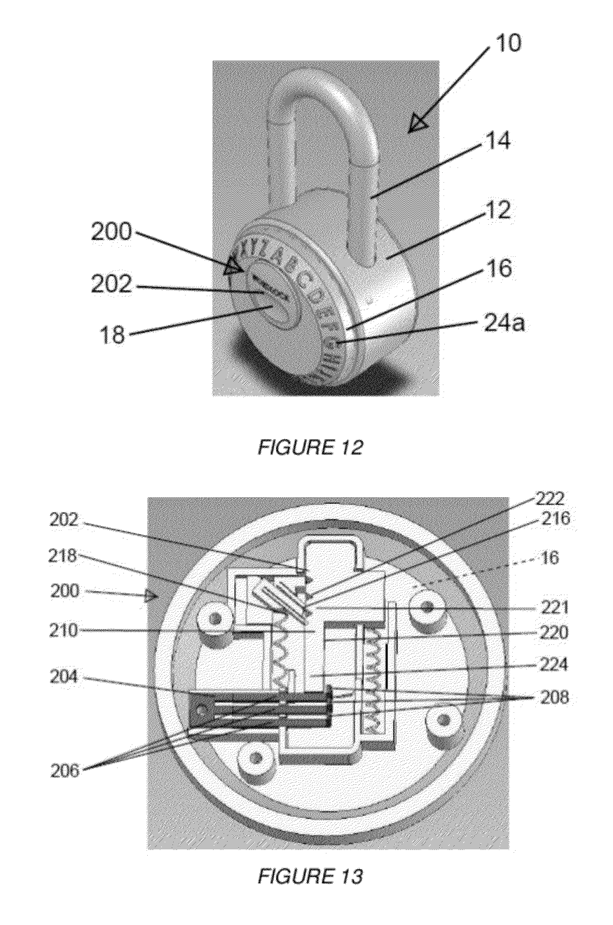

FIG. 13 is a schematic, partially cut away, rear isometric view of a dial mechanism of the lock assembly.

FIG. 14 is a cross-sectional view of the dial mechanism of FIG. 13 showing a cam end of the rack-cam in a position to lift the dial spring fingers.

FIG. 15 is an isometric view of push-button selection mechanism.

FIG. 16 is an isometric and partial side elevation views of push button selection mechanism.

FIG. 17 is an isometric view of push-button selection mechanism.

FIG. 18 is an isometric view of push-button selection mechanism.

FIGS. 19A and 19B are enlarged partial isometric views of the button and ratchet.

FIG. 20 is an isometric view of push-button selection mechanism.

FIG. 21 is an isometric view of push-button selection mechanism.

FIGS. 22A-22D are schematic, partial rear elevation views of the dial mechanism showing positions in a sequence of a linear ratchet system when unlocking the lock assembly.

FIGS. 23A-23D are schematic, partially cut away isometric views of the dial mechanism with a slide button with a “J”-shaped slide path.

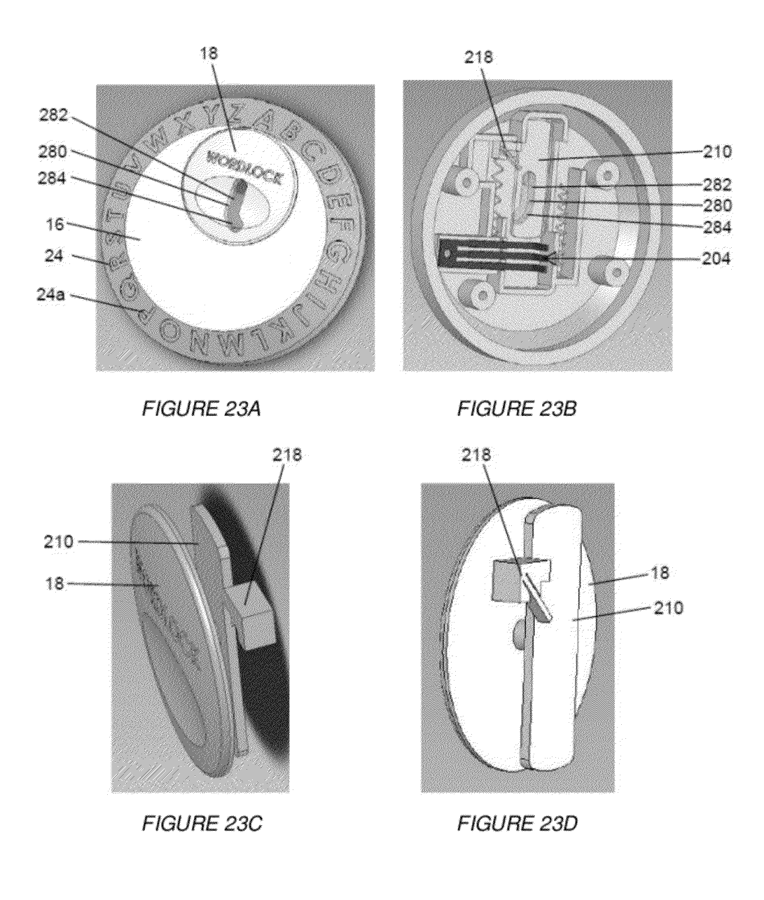

### DETAILED DESCRIPTION

The present disclosure is directed toward resettable, combination dial lock assemblies that provide a directionally independent, spin-and-click combination selection configuration and associated methods of manufacture. Several specific details of the new technology are set forth in the following description and the Figures to provide a thorough understanding of embodiments of the technology. Additionally, many of the features shown in the Figures are merely illustrative of particular embodiments of the technology. One skilled in the art, however, will understand that the new technology may have additional embodiments, and that other embodiments of the technology may be practiced without several of the specific features described below.

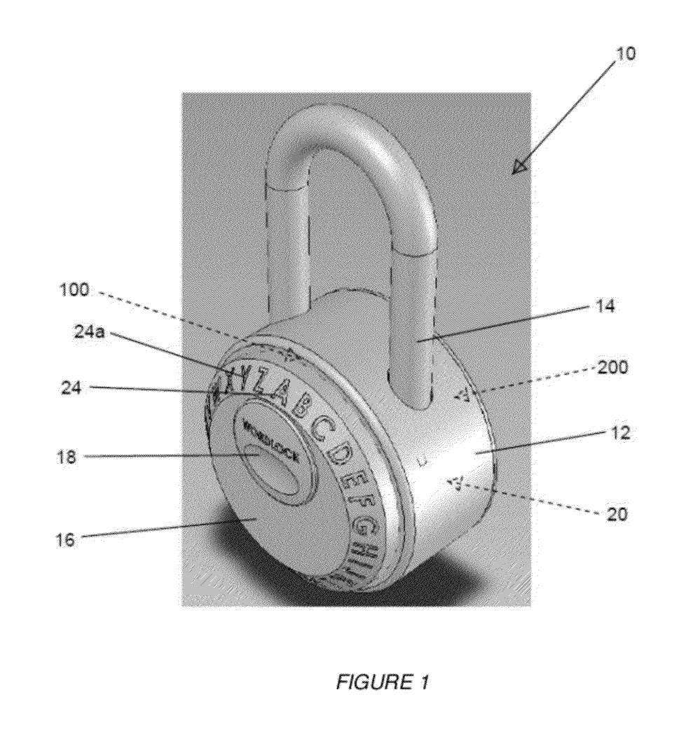

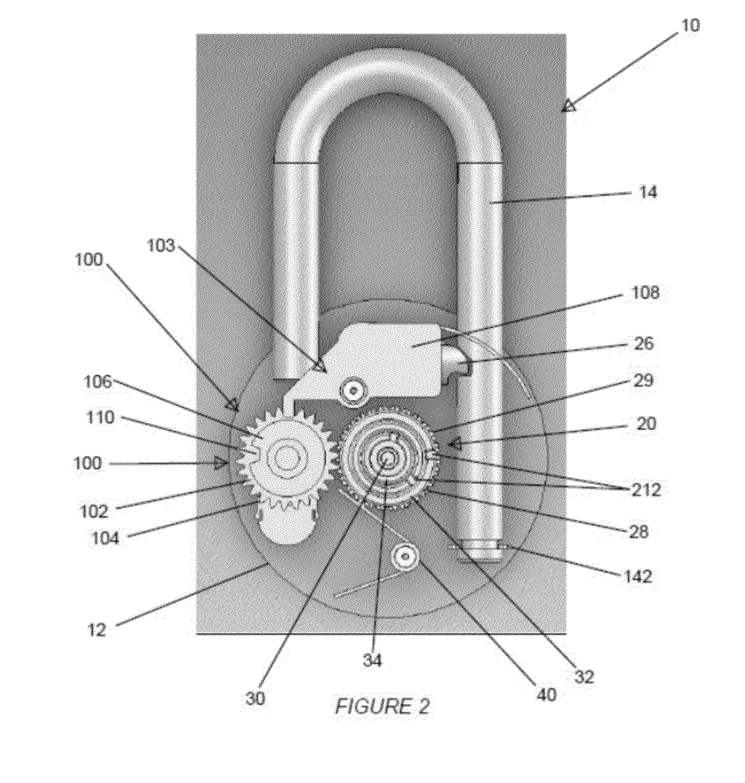

Embodiments of the new technology are directed to resettable, dial lock assemblies 10 with the directionally independent spin-and-click configuration. In one embodiment illustrated in FIGS. 1 and 2, the lock assembly 10 is a combination padlock that comprises a housing 12, a shackle 14, a dial 16 rotationally disposed relative to the housing 12, a selector (shown as a button 18), and a combination disc assembly 20 with a plurality of internal combination discs 22 (FIG. 2) rotationally independent of one another in establishing the combination for opening the lock. Each combination disc 22 can be directly dialed in either direction (clockwise or counter clockwise) by rotating the dial 16 to the digit 24 (number, letter, mark, symbol, color, or other indicia) on the dial 16 corresponding the element of the combination without needing to pass by another digit of a previously dialing. In other words, if the lock assembly 10 has letters 24a on the dial 16, and the lock has a four digit combination, such as “BACK”, the user could rotate the dial 16 to and select each of “B” “A” “C” and “K” sequentially in any rotational direction and independent of the direction or rotational distance traveled by the dial 16 (and corresponding combination discs) between the combination elements.

In one embodiment, the lock assembly 10 has four combination discs 22, corresponding to a four-digit combination. In other embodiments, the lock assembly 10 can include two, three, five, or more combination discs corresponding to combinations having two, three, five, or more digits. The lock assembly 10 can be resettable, wherein the combination to unlock the assembly can be reset to a new combination, such as when the lock is in the unlocked and reset state. In other embodiments, the lock assembly 10 may have a predetermined, non-resettable combination. The dial 16 may include a plurality of positions corresponding digits 24 defined by a plurality of letters, numbers, symbols, colors, mark, or other indicia, and/or any combination of these indicia. In one embodiment, the dial 16 includes twenty-six positions corresponding to letters A-Z. In another embodiment, the dial includes forty numerical digits 24 corresponding to 0-39. Other embodiments have other numbers of positions corresponding to selected indicia on the dial 16.

The illustrated lock assembly 10 includes three primary and unique subassemblies to the lock which include the:
I. Combination-disc assembly 20;
II. Combination change an lever drop assembly 100; and
III. Dial-dialing assembly 200.

Although interrelated, each subassembly will be first discussed individually and then combined as a total assembly. Other features, whether directly related to the section will be discussed in amongst each of these subassembly sections.

### I. Combination Disc Assembly:

As indicated above, the lock assembly 10 includes a subassembly referred to herein as the combination disc assembly 20. The combination disc assembly 20 of the illustrated embodiment includes a plurality of the combination discs 22 within the housing 12 and coupled to the dial 16 (FIG. 1). The combination discs 22 are independently rotatable relative to each other upon rotation of the dial 16 for sequentially entering the combination to unlock the lock assembly 26 (i.e., to release the shackle 14 and allow a portion of the shackle to disengage from the locking mechanism 26 in the housing 12). The combination disc assembly 20 described herein is configured such that the combination discs 22 are dialed independently of one another. This arrangement allows the combination discs 22 to rotate in either direction to a position corresponding to the selected combination digit 24 independent of the rotational direction and/or distance travel of the other combination discs 22 when being moved to their corresponding combination digit 24.

Many conventional combination dial locks use internal rotation elements (often 3 rotation elements) that are dependent on one another within the lock body when dialing to properly enter the combination to unlock the dial lock. For example, the dial is connected to the three rotation elements, and the user rotates the dial through several full revolutions, such that adjacent rotation elements engage each other and rotate together as a unit. Rotation of the dial through a full 360 degrees will result in at least two or more rotation elements engaging each other and rotating together as the user rotates the dial. Accordingly, each rotation element is in contact with (and dependent on) the adjacent rotation elements at some point throughout this dialing sequence establishing the unlocking combination of the lock.

As is well known, it is common with conventional dial lock designs (e.g., a Master Lock® 1500 combination wheel padlock) to rotate the dial, and thus the internal discs clockwise (to the right) several (2+) revolutions to assure all discs are in contact with the adjacent disc. This contact is often through protruding nubs from both sides of the combination discs which engage and drive similar nubs on the adjacent disc as the user rotates the dial. The first digit of the combination is typically dialed in this initial step by rotating the dial (and thus all of the discs) to a selected position corresponding to the digit of the lock's combination. The second digit of the combination is then dialed by rotating the dial over one full rotation (i.e., 360+ degrees) counterclockwise past the combination's first digit to the combination's second digit. The combination's third digit is then directly dialed by rotating the dial clockwise. This type of combination lock progressively dials each disc through an adjacent disc in a prescribed direction (CW, CCW, CW) essentially disconnecting two adjacent discs as the direction is changed. Accordingly, these discs in the prior art dial locks are dependent upon each other for rotation in the selected alternating directions to properly dial the combination to unlock the combination lock.

The combination dial lock assembly 10 of the present disclosure is configured to allow the user to progressively dial each combination disc 22 directly to the defined digit 24 regardless of rotational direction and without needing to dial past a previous digit 24 therefore being independent of where the previous disc 22 may have been dialed. The progressive dialing of each disc 22 is controlled by the combination disc assembly 20. This design using independently driven combination discs 22 also simplifies the ability to increase the number of combination discs to beyond three, which is a significant improvement over existing designs.

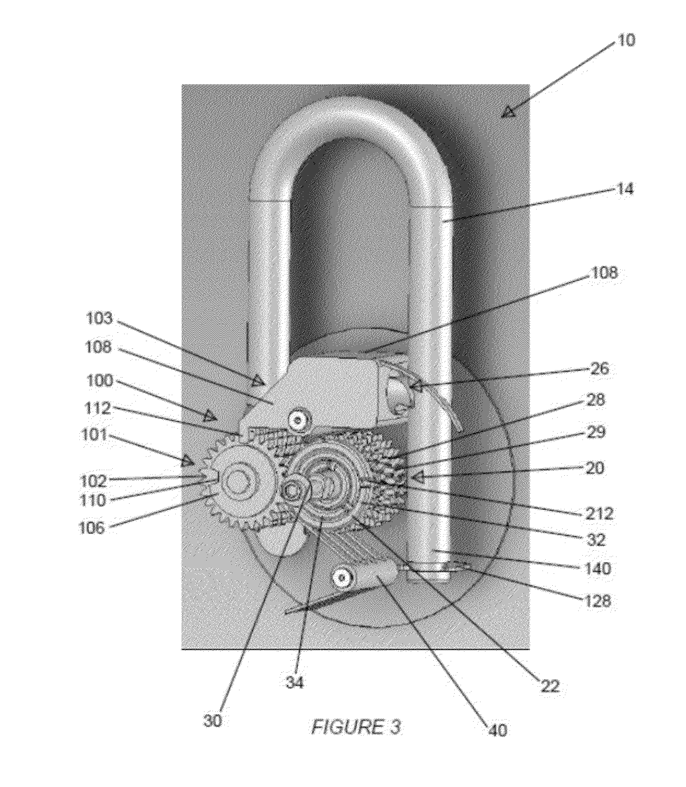

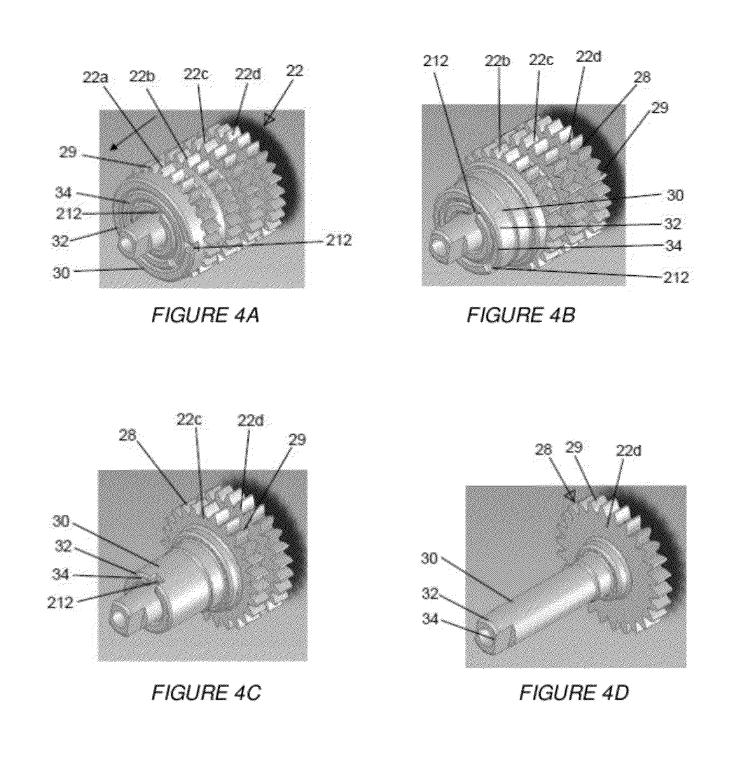

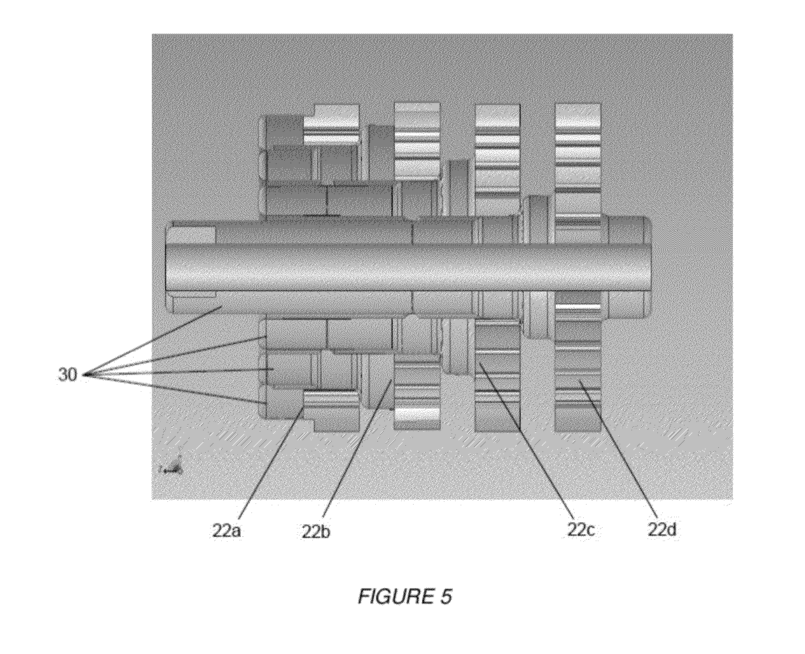

As is seen in FIGS. 2-5, the combination disc assembly 20 of the illustrated embodiment includes four axially aligned discs 22 nested together and independently rotatably relative to each other. Each disc 22 includes a plurality of outer gears 28 that have substantially the same diameter, so the gears of the discs 22a, 22b, 22c, and 22d are stacked relative to each other. Each of the gears 28 includes a plurality of gear teeth 29 around its circumference, such that rotation of the disc 22 causes the gear teeth 29 to rotate about the axis of the disc. Each disc 22 also has a central shaft 30 portion with a distal end 32, and each distal end 32 includes a dial drive portion 34 configured to be releasably engaged by a portion of the dial 16 (FIG. 1). In the illustrated embodiment, the dial drive portion 34 is a notch, although other configurations can be used. When the dial 16 engages the dial drive portion 34 of the discs, rotation of the dial results in rotation of the disc 22. When the dial 16 is disengaged from the disc's dial drive portion 34, that disc 22 will not rotate when the dial 16 is rotated, while the remaining discs in engagement with the dial will rotate together with the dial. This allows the dial 16 and a disc 22 to be rotated in either direction to a selected position corresponding to the digit of the combination, and then the dial 16 can be disengaged from the disc (such as the first disc 22a), while the other discs 22b, 22c, and 22d remain in engagement with the dial 16. The dial and the remaining engaged discs 22b, 22c, and 22d can then be rotated in any direction directly to the next digit of the combination, wherein the next disc (i.e., the second disc 22b) will be disengaged from the dial. The dial 16 and the remaining engaged discs 22c and 22d can then be rotated in either direction to the next digit of the combination until the entire combination has been dialed to unlock the lock assembly 10.

The fourth disc 22d in the illustrated embodiment also has the gears 28 and the central shaft portion 30. The central shaft portion 30 in this embodiment is configured to securely engage the dial 16 (FIG. 1) at all times, such that when the dial 16 rotates, the fourth disc 22d will rotate. Accordingly, while the first, second and third discs 22a, 22b, and 22c, respectively, can disengage from the dial and not rotate while the dial rotates, the fourth disc 22d does not disconnect from the dial. In other embodiments, the last disc (e.g., the fourth disc 22d) can be configured to be disengagable from the dial as desired or needed.

The discs 22 of the illustrated embodiment are configured to nest together as shown. The discs 22, however, are arranged in a manner to minimize or otherwise reduce friction between the discs. This reduced friction allows one or more discs 22 to rotate relative to another disc 22 that is disengaged from the dial 16. This reduced friction also makes the dial 16 easier and smoother to rotate, such as when dialing the lock's combination. The illustrated embodiment also includes a friction spring 40 (discussed in greater detail below) that engages the gears 28, such as the gear teeth 29, on the discs 22 to hold the discs in place after being disengaged from the dial. This avoids the disengaged discs from drifting past the position after disengagement from the dial.

### II. Combination Change And Lever Drop Assembly:

The lock assembly 10 of the illustrated embodiment includes the combination change and lever drop assembly 100 that allows the user to change the unlocking combination of the lock assembly, thereby allowing the user to select a unique combination for security reasons, or which they may remember more easily, or should they choose to have multiple locks with common combinations. The combination change and lever drop assembly 100 includes a combination change assembly 101 coupled to a lever drop assembly 103. The combination change assembly 101 has a separate stack of change wheels 102 adjacent to the nested stack of discs 22 of the combination disc assembly 20 discussed above. The combination change assembly 101 has the same number of change wheels 102 as the number of discs 22 in the combination disc assembly 20. In the illustrated embodiment, the lock assembly 10 has a stack of four discs 22 and a separate stack of four change wheels 102. Each change wheel 102 is substantially coplanar with a respective one of the discs 22. Each change wheel 102 of the illustrated embodiment is a gear with gear teeth 104 on its outer periphery that engage the gear teeth 29 of the gears 28 on the outer periphery of the adjacent disc 22. Accordingly, rotation of the dial 16 (FIG. 1) causes rotation of the engaged discs 22, which in turn causes rotation of the respective change wheels 102.

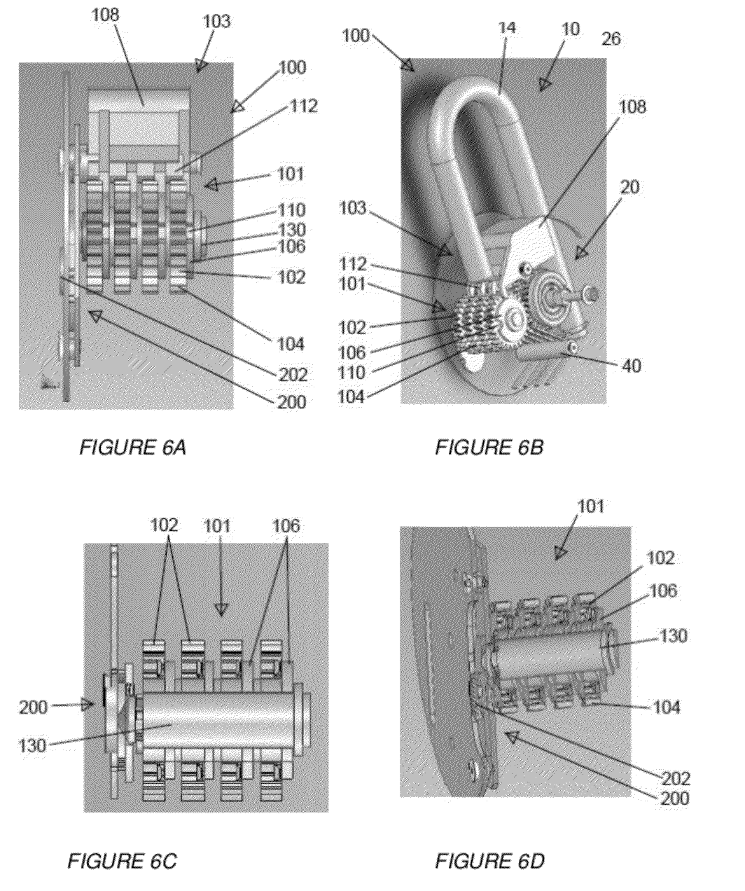

As seen in FIGS. 6A-8B, the combination change assembly 101 is partly independent of the combination dialing assembly 20. The combination change assembly 101 is mounted on its own axis parallel with the axis of the discs 22 discussed above. The combination change assembly 101 in the illustrated embodiment includes the plurality of geared change wheels 102 that are releasably connected to notched change hubs 106. Each change wheel 102 is keyed and meshed together with a respective one of the change hubs 106. The change wheel 102 and its respective change hub 106 are axially moveable relative to each other to allow axial separation therebetween. When the change wheel 102 is axially separated from its change hub 106, the change wheel can be rotated relative to the change hub to a selected position by rotating the dial 16 (FIG. 1) and the corresponding disc 22 via the geared interconnection between the disc 22 and the change wheel 102. After the change wheel 102 is moved to the selected position (e.g., when changing the combination of the lock assembly 10), the change wheels 102 and/or the respective changed hubs 106 are moved axially back into engagement with each other. In this example, four pairs of change wheels 102 and change hubs 106 are shown, which equal the number of combination discs 22, as discussed above.

The illustrated embodiment provides separate, adjacent stacks of the discs 22 and change wheels/hubs 102/106. This arrangement allows the size of the lock's housing 12 (i.e., the axial depth of the lock) to be minimized. This arrangement also allows for simplified subassemblies that work together and for better locations and orientations of the other lock components (i.e., the shackle 14 and a lever 108 of the lever drop assembly 103) about the two semi-independent subassemblies, versus one larger and more complex assembly. Other embodiments, however, could include the discs 22 in axial alignment with the change discs/hubs 102/106.

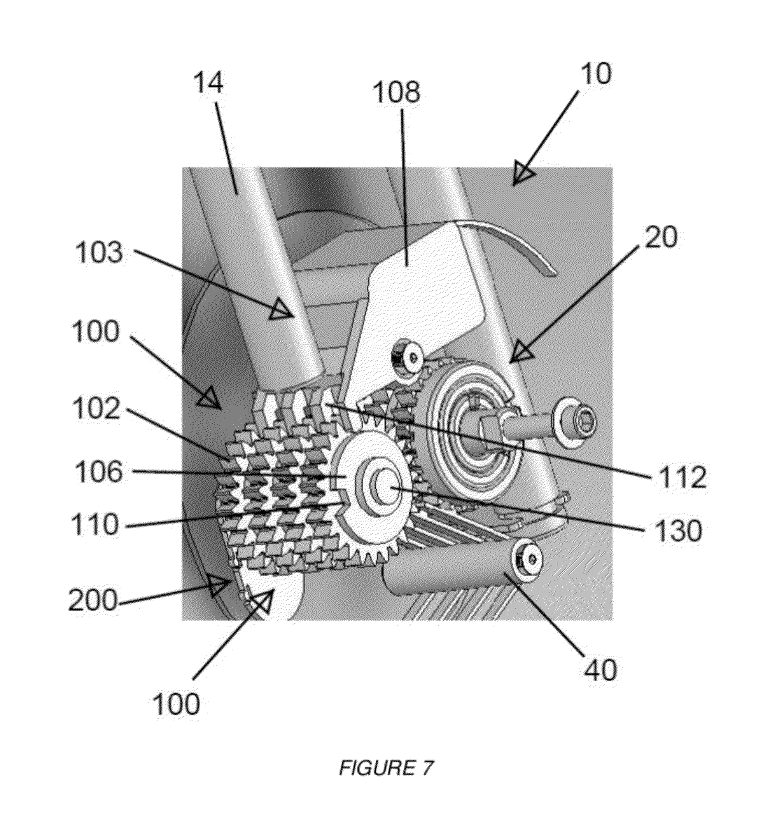

As seen in FIG. 7, the change wheels/hubs 102/106 are adjacent to the lever drop assembly 103, such that lever fingers 112 on the end of the lever 108 are spaced apart and each lever finger is immediately adjacent to a respective one of the change hubs. The change hubs 106 in the illustrated embodiment include notches 108 that rotate with the change wheels 102 as the dial 16 (FIG. 1) and engaged discs 22 rotate. When the user dials the combination of the lock assembly 10, the user rotates the dial, which is initially engaged to all of the discs 22, to the first digit of the combination. As the discs 22 rotate to the first digit position, the engaged discs cause the change wheels 102 and associated change hubs 106 to rotate. When, as an example, the dial 16 reaches the position corresponding to the digit of the combination, the first disc 22a will have rotated the first change wheel 102a and the associated first change hub 106a so that the notch 110 in the first change hub 106a is directly below or otherwise aligned with the first lever finger 112a of the lever 108 of the lever drop assembly 103. Accordingly, when the change hubs 106 are rotated via the change wheels 102, discs 22, and dial 16 in either direction so that the notch 110 in a change hub is aligned below the lever fingers (so as to allow the lever fingers 112 to drop into the notch), the resulting position of the dial will correspond to the digit of the combination for that position.

To enter the lock assembly's combination, the user rotates the dial 16 in either direction (CW or CCW) to the first digit of the combination when all of the discs 22 are engaged to the dial, so that the first disc 22a rotates the first change wheel 102a until the notch 110 in the first change hub 106a is aligned with the corresponding lever finger 112a. The first disc 22a is then disengaged from the dial 16, and dial 16 is rotated in either direction to the second digit of combination, whereby the remaining discs 22b-22d are rotated until the second disc 22b rotates the second change wheel 102b and associated change hub 106b to align the corresponding notch 110 with the lever fingers 112. The first change hub 106a and its notch 110 remain in position under the lever fingers 112 because the first disc 22a has been disengaged from the dial, and the friction spring 40 prevents the first disc/first change wheel/first change hub from moving out of position while the other discs rotate.

The second disc 22b is disengaged from the dial 16 and the process is repeated for the third disc 22c (rotating the dial in either direction) to the third position corresponding to the third digit of the combination with the notch 110 in the third change hub 106c being aligned with the lever fingers 112. The third disc 22c is disengaged from the dial 16, and the process is repeated for the fourth disc 22d. When the final notch 110 in the change hub 106d of the fourth change wheel 106d is aligned with the lever fingers 112 (corresponding to the last digit of the combination), the lever fingers 112 can drop into the four aligned notches 110, thereby allowing the lever 108 of the lever drop assembly 103 to rotate and release locking mechanism 26 from the shackle 14, thereby unlocking the lock assembly 10. The shackle can thereby lift relative to the housing 12 and open.

The change wheels 102 have the gear teeth 104 on the outer diameter that mate to the gear teeth 29 on the outer diameter of the combination discs 22. The gear ratio is set at a 1:1 ratio keeping the change wheels 102 and the discs 22 from both assemblies in synch (in consistent reference to one another) regardless of the number of rotations on the dial. As the combination discs are rotated by the dial (and dialing mechanism), the combination discs rotate the change wheel and engaged hub pairs. When dialed to a prescribed combination, the notches on the hubs all align allowing the lever fingers to drop into the notches and the lock to open. In this same state wherein the notches are all aligned so that the lock can open, the combination of the lock can be changed (as discussed in greater detail below). Accordingly, this subassembly is termed the combination change and lever drop assembly 100.

As discussed above, the discs 22 of the combination disc assembly 20 physically engage the change wheels 102 view the interface between the gear teeth 29 and 104. During rotation of the discs 22 and the change wheels 102, upon rotation of the dial 16 (FIG. 1), the position of the notch 110 in the change hub 106 relative to the corresponding change wheel 102 remains fixed. Whenever the dial 16 is moved to the digit of the combination corresponding to a combination disc 22, the notch 110 in the change hub 102 corresponding to the same disc will be always be positioned in alignment with the fingers 112 of the lever drop assembly 103. This arrangement will remain fixed until the combination is reset. When the combination is changed, the change hub 106 is re-oriented relative to its corresponding change wheel 102, such that the notch 110 in the change hub is at a different angular position relative to the respective change wheel. Since the change wheel 102 and corresponding disc 22 are engaged via the gears 28 and 104 in the 1:1 ratio, changing the position of the hub will result a change in which indicia on the dial corresponds to the digit for the combination. Accordingly, the lock assembly's combination can be changed by changing the position of one, more than one, or all of the change hubs 106 relative to their corresponding change wheel 102.

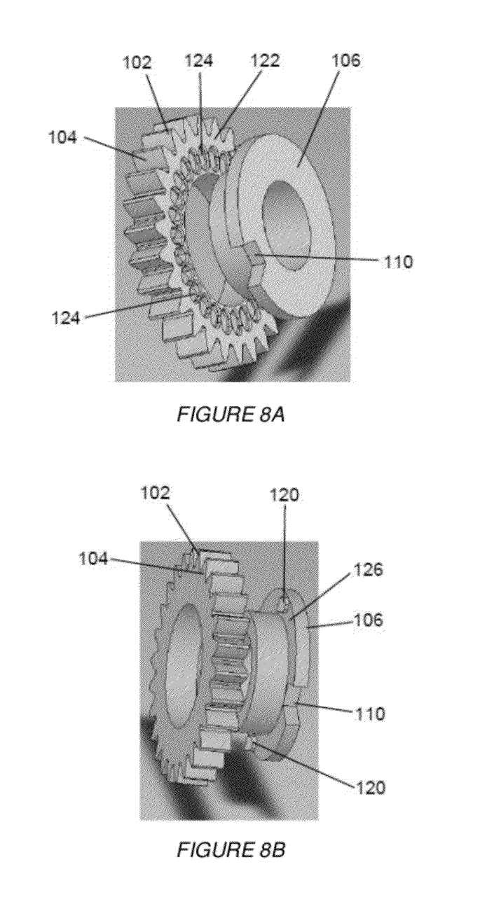

As seen in FIGS. 8A-8B, the change wheels 102 and notched change hubs 106 are configured to allow for a discrete angular re-orientation (shown at 26 increments, but greater or fewer increments could be used in other embodiments) of each hub 106 relative to the mating change wheel 102 through a meshing of teeth or drive splines 120. In the illustrated embodiment, the change wheel 102 has a substantially planar face 122 with engagement features, such as twenty-six spline pockets 124. The change hub 106 has a substantially planar mating face 126 parallel to the face 122 of the change wheel 102, and the change hub 106 has one or more engagement features, such as one or more drive splines 120, projecting from the hub's face 126. When the hub 106 is in an engaged position relative to its respective change wheel 102, the planar faces 122 and 126 are immediately adjacent to each other (and can be in physical engagement with each other), and the splines 120 on the hub 106 extend into the spline pocket 124 on the change wheel 102. This engagement between the spline 120 and spline pockets 124 (i.e., the engagement features) causes the hub 106 to rotate with the change wheel 102 as a unit when the hub 106 is in the engaged position.

By changing the position of the hub 106 relative to the change wheel 102 (i.e., by changing which spline pocket 124 receives the spline 120), this provides a new angular relationship between the notch 110 on the hub 106 and the change wheel 102, thereby changing the positional relationship with the corresponding combination disc and its dial drive portion 34. The changing of this orientation allows for the unique programming of each combination digit. The re-orientation between the change wheel 102 and hub 106 is accomplished by the axial separation of the pair's interface allowing relative angular rotation between the face 126 of the hub 106 and the face 122 of the change wheel. In the illustrated embodiment, this axial separation can only occur when the lock assembly 10 is in the unlocked state where the notches are all aligned with the fingers 112 of the lever 108 (as discussed in greater detail below).

While the meshing feature is described above and shown as radial splines on the mating faces 122 and 126 between the change wheel 102 and hub 106, other embodiments can use one or more an axial splines on the bore of the wheel relating to a mating spline on the outer diameter of a portion of the hub. Other embodiments can use other suitable engagement features for releasable and/or resettable engagement between the change hub 106 and its corresponding change wheel 102. It can be advantageous to use larger more robust meshing or engagement features that can be larger (stronger and easier to manufacture) than the axial bore splines. It may also allow for a greater number of discrete combinations since more meshing features can be allowed for a given minimal feature size.

In the illustrated embodiment, the change wheels 102 and the change hubs 106 are carried on a shaft 130, and the change wheels 102 can be axially constrained on the shaft, such as by the lever drop fingers 112 and/or by a biasing member or an independent, additional component, but allowed to rotate for combination reset. The notched change hubs 106, however, are not axially constrained on the change shaft 130, but are constrained from rotation when in the engaged position. When the lock assembly 10 is in position to allow the user to reset the combination, the notched hubs 106 are allowed to axially stroke with the shaft 116 and relative to the corresponding change wheels 102, thereby allowing separation from the change wheels 102 at the spline interface. The shaft 130 can be stroked in a number of ways using a tool or tool-less configuration.

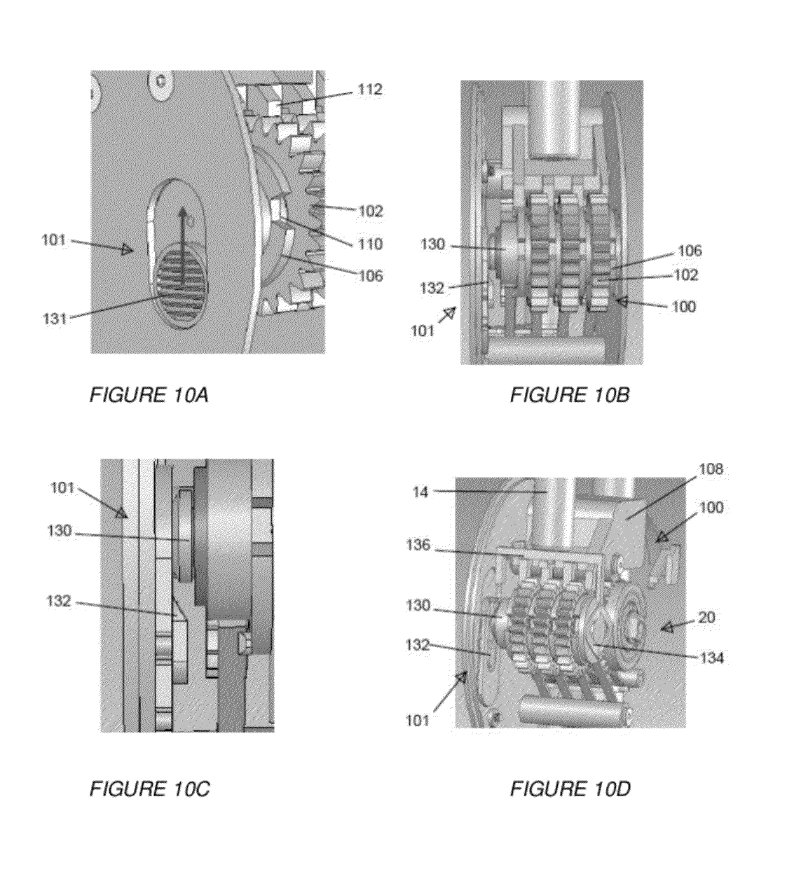

The illustrated embodiment shown in FIGS. 10A-10D has an integrated (to the lock) sliding change cam 132 that is operatively connected to a change button 131 and that acts on the end of the change shaft 130 separating the notched hubs 106 from the change wheels 102. A change shaft spring 134 biases the shaft 130 back against the sliding cam 132, but more importantly holds the mating or meshed surfaces of the wheel 102 and hub 106 together in the engaged position in normal lock operation. When the change cam 132 is in the change position, the shaft 130 is stroked (moved axially) and the wheel 102 and hub 106 are separated. The hubs 106 are prevented from rotating by the engaged lever 108. The lock assembly 10 is then taken through a combination-dialing sequence by rotating the dial 16, which rotates the combination discs 22 and repositions the change wheels 102 relative to the hubs 106 to the new combination. Once the combination is reset, the change cam 132 is released returning the shaft 130 and hubs 106 axially relative to the change wheels 102, thereby re-engaging the hubs 106 to the wheels 102.

As shown in FIG. 10D, an intermediate and independent change blocker 136 acts between the change button 131 and the shackle 14. When the shackle 14 is in the locked (down) state, the blocker 136 is held also downward so as to block raising or otherwise moving the change button 131 (shown as a slide button). If the shackle 14 is unlocked (up), the blocker 136 is free to move upward along with the sliding change button 131, thereby moving the shaft axially to allow for changing of the combination. In one embodiment, the blocker 136 could be an integral part of the change button 131. In other embodiments the blocker 136 and change button 131 can be separate components.

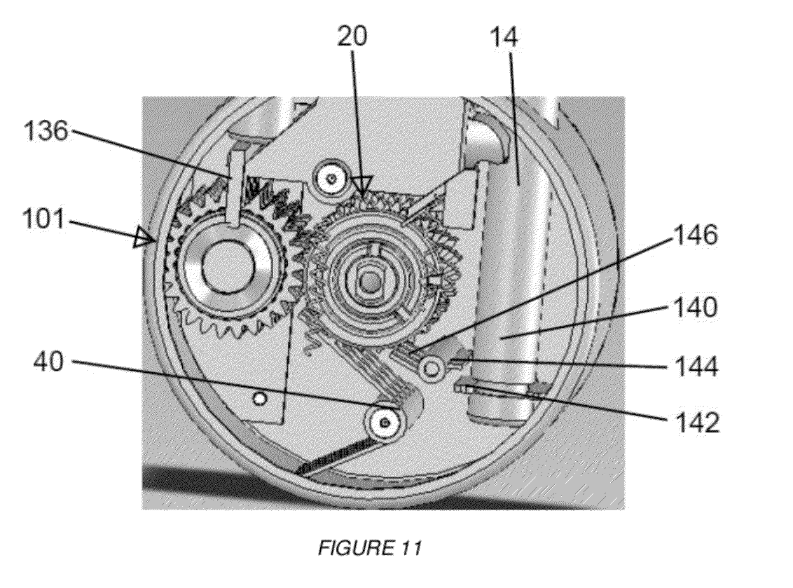

The friction spring (or feature) 40 shown in FIG. 11 prevents the friction from the combination discs 22 sliding over one another when dialing (i.e., rotating) from mistakenly moving/rotating the adjacent disc 22 out of place once positioned during the combination dialing sequence. The frictional torque between the gear teeth 29 and the friction spring 40 is much higher than the friction/drag between the combination discs 22. The friction spring 40 could act on either the combination disc assembly 20 or the change wheels and lever drop assembly 100, such as the gear teeth 104 or other surfaces since they are meshed together. The friction spring 40 also prevents external shaking, vibration or dropping from allowing the combination discs 22 from inadvertently moving out of position once set. The friction spring 40 also prevents the combination discs 22 and associated change assembly wheels 102 from inadvertently rotating relative to one another and losing the combination when in the combination mode.

The end portion 140 of the shackle 14 that remains in the housing 12 includes a retaining clip 142 that protrudes from the shackle. When the shackle 14 is in the lowered, closed position, the retaining clip 142 is below a pivot spring mechanism 144. The pivot spring mechanism has a plurality of engagement prongs 146 positioned to engage and rotate the combination discs 22. When the shackle if lifted from the lowered, closed position to the open, unlocked position, the retaining clip 142 engages and moves past the pivot spring mechanism 144 to the engagement prongs 146 pivot away from the combination discs 22. When the shackle 14 is moved from the open, unlocked position to the lowered, closed position, the edge of the retaining clip 142 will engage and rotate the pivot spring mechanism 144, thereby causing the engagement prongs 146 to engage and rotate the combination discs 22. This automatic rotation of the combination discs 22, when the shackle is closed results in an automatic spinning of one or more of the combination discs 22 through the pivot spring mechanism 144 as it rotates, resulting in the combination discs 22 automatically moving away from the unlocking position. The pivot spring mechanism 144 is only actuated and will engage the combination discs 22 when the shackle 14 is closed, thereby causing the combination discs 22 to automatically rotate away from the unlocked position (i.e., automatically “scrambling” the lock). This scrambling of the lock assembly 10 results in automatically locking the shackle 14 when the shackle is closed. The shackle 14 can then be opened by re-inputting the combination.

### III. Dial Dialing Assembly:

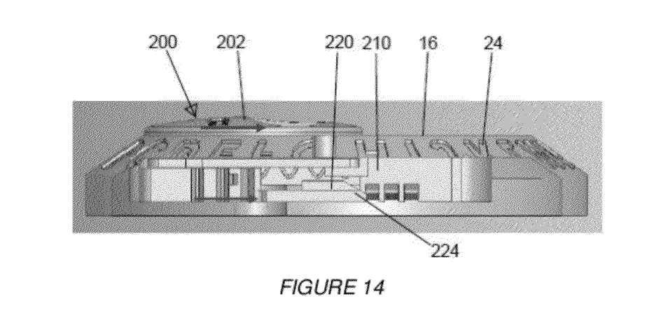

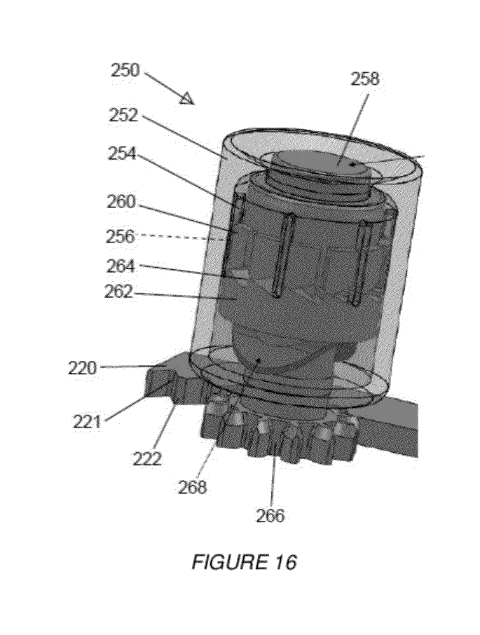

As shown in FIGS. 13 and 15, the lock assembly 10 includes the dial dialing assembly 200 configured to interact with the combination disc assembly 20 to engage/disengage the combination discs 22 when dialing the combination. The dial dialing assembly 200 of the illustrated embodiment includes a selection mechanism 202 coupled to the dial 16, the selector button 18, and the combination disc assembly 20 (FIG. 2). The selection mechanism 202 is activated upon pressing or sliding the selector button. The selection mechanism 202 is positioned adjacent to a spring finger assembly 204 that engaged the combination discs 22 at the dial drive portion, such that rotation of the dial will simultaneously rotate the discs 22. The spring finger assembly 204 can be selectively and sequentially disengaged from the discs 22, so that the disengaged discs will not rotate with the dial, while the discs still in engagement with the spring finger assembly 202 will continue to rotate with the dial 16, such as when a user enters the combination. In the illustrated embodiment, the spring finger assembly 202 has three spring dialing fingers 206, and each finger is associated with a respective disc 22. When activated, the selection mechanism 202 of the illustrated embodiment progressively lifts one of the three spring dialing fingers 206, so as to disengage from the respective disc 22, when the slide button 18 is actuated toward the middle of the dial. The spring finger assembly 202 of the illustrated embodiment has three spring dialing fingers 206 because the illustrated lock has four combination discs 22, one of which is fixed to always rotate with the dial 16. Accordingly, a three-digit combination lock could include two spring dialing fingers 206, and a five-digit combination lock with five combination discs 22 would have four spring dialing fingers 206.

The spring dialing fingers 206 have end portions 208 aligned with notches 212 in the distal ends of the combination discs 22 at the dial drive portions. The spring dialing fingers 206 are configured to releasably engage the combination discs 22 as discussed above so the combination discs 22 will rotate with the dial 16 when the user rotates the dial. The selection mechanism 202 has a selector plate 210 connected to the selector button 18, which can be a slide or a depressible button. The selector plate 210 is moveable relative to the three spring dialing fingers 206 from a start position, wherein the spring dialing fingers 206 are all disposed in the discs' notches 212 and engaged with the discs 22. The selector of the illustrated embodiment is a slide button integrally connected to the slidable selector plate 210, but other selectors can be used in other embodiments.

In operation, when the three spring dialing fingers 206 are disposed in the notches 212 of the discs 22 such that rotation of the dial 16 rotated all of the discs 22, this is the combination starting position. From this starting position, when the button 18 is slid or otherwise moved to a first position, such as when the dial 16 has been rotated to the first digit of the combination, the sliding of the button causes the selector plate 210 to slide relative to the spring dialing fingers 206, so that the first finger of the spring dialing fingers is lifted or otherwise raised and moved out of the notch 212 and out of engagement with the first disc 22 (FIG. 2). Accordingly, from the start position the user rotates the dial 16 in either direction (CW or CCW) to the first digit of the combination, and selects it by moving or otherwise activating the button 18 to move the selector plate 210 to the first position, with the first finger 206 lifted out of the notch 212 and out of engagement with the first disc. The dial 16 can then be rotated in either direction to the second digit of the combination, but the first disc 22 will not rotate away from the first selected position.

When the button 18 and/or the slide plate 210 are moved to a second position, such as after the dial 16 has been rotated to the second digit of the combination, activation of the button 18 causes the selector plate 210 to slide under and lift the second finger 206 of the spring finger assembly 204 out of the second notch 212 and out of engagement with in the second disc. Accordingly, the user dials the second digit of the combination, and selects it by moving the button to the second position, such that the dial 16 can then be rotated in either direction to the third digit of the combination, but the first and second discs 22 will not rotate away from the first and second selected positions.

When the button 18 is moved again to a third position, such as after the dial 18 has been rotated to the third digit of the combination, the button 18 causes the selector plate 210 to slide under and lift the third finger 206 to disengage from the third disc 22. If the first, second, and third digits of the combination have been sequentially and properly selected, when the dial 16 is then rotated in either direction to the fourth digit of the combination, the notches 110 in the change hubs 106 (FIG. 2) will all be aligned with all of the lever fingers 112, so the drop lever 108 will drop into the notches 110 in the hubs 106 and the shackle can be opened. The selection mechanism 202 is returned to a home (reset) state where all the fingers 206 are extended (e.g., lowered) and moved back into engagement with the respective discs 22 by activating the selector 18, such as by sliding the button back to the start position or another extreme position that resets the selector.

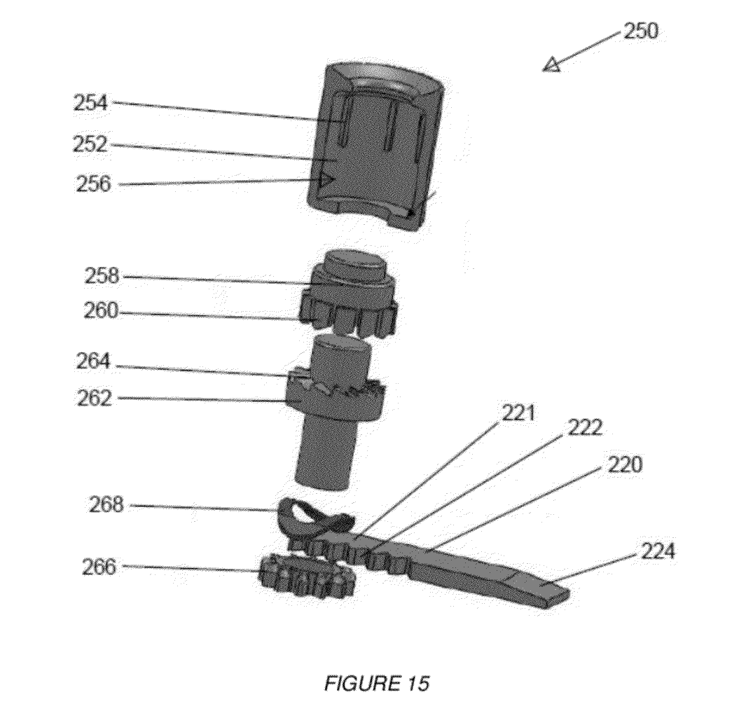

In one embodiment shown in FIGS. 13 and 14, the dial dialing assembly 200 includes a linear ratcheting mechanism 216 with a rack-cam device 220 having rack portion 221 with a plurality of teeth 222 forming a rack at one end and a cam portion 224 at the other end. The cam portion 224 is positioned to engage and lift the spring dialing fingers 206 as discussed above. A flexible button lever spring 218 is connected or otherwise coupled to the linear ratcheting mechanism 216 and to the button 18 (or other selector mechanism). As the button 18 is moved through a linear stroke from the starting position to the first position, the button lever spring 218 engages the teeth 222 of the rack-cam device 220 and strokes it forward until the stationary lever spring 218 engages the rack teeth 222. Subsequent strokes of the button 18 to the second and third positions progressively position the rack-cam device 220 radially inward toward the center of the dial 16. As this ratcheting of the rack-cam device 220 occurs, the cam portion 224 of the rack-cam device 220 sequentially engages and lifts the first, second and third fingers 206 of the spring finger assembly 204 as discussed above.

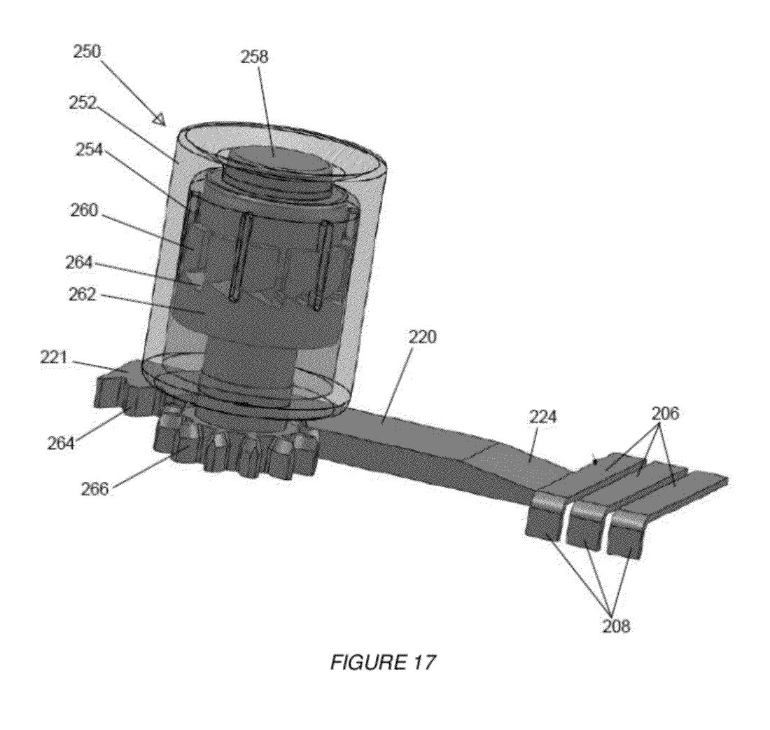

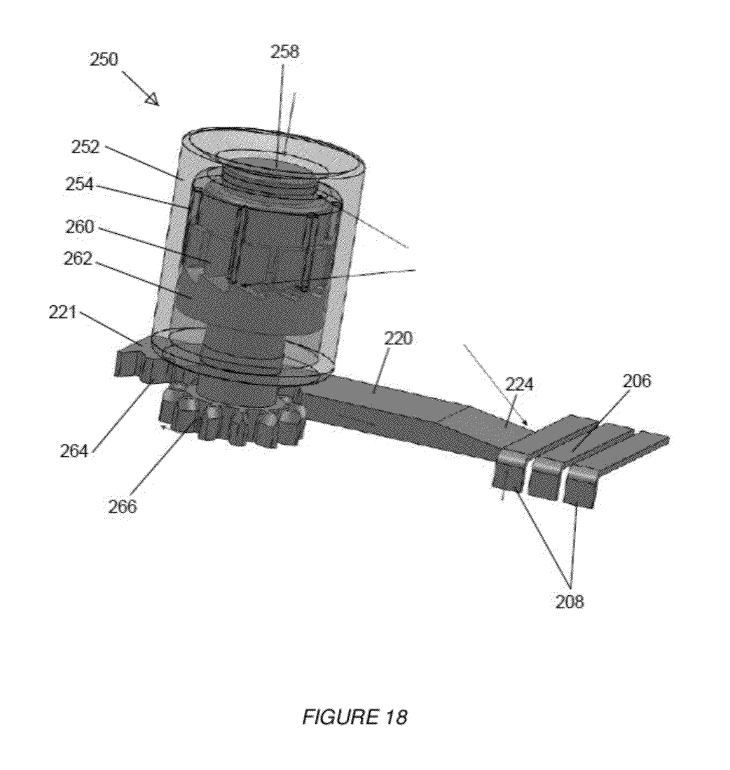

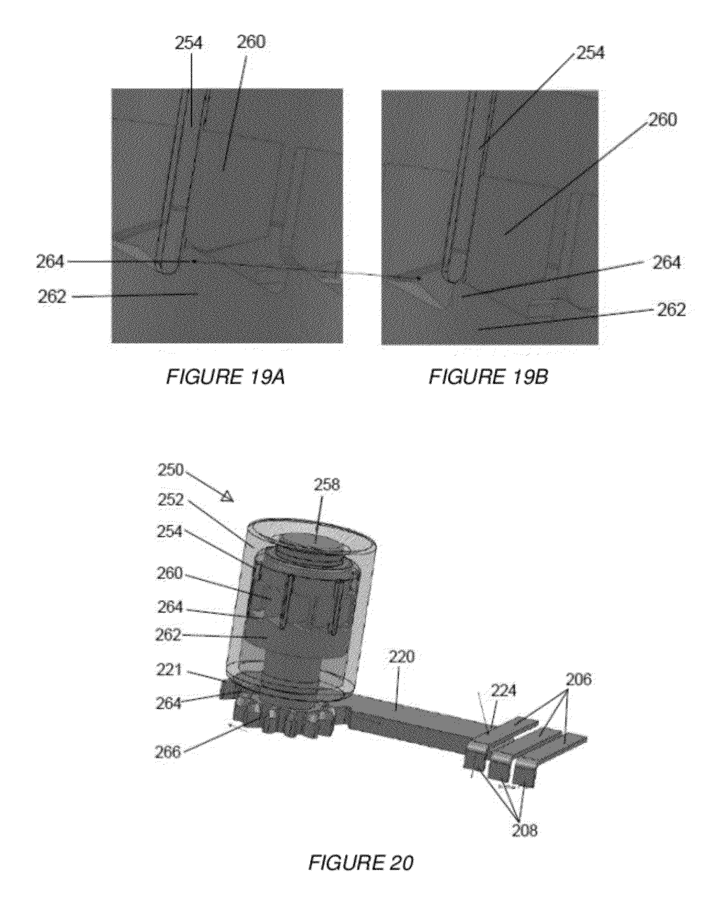

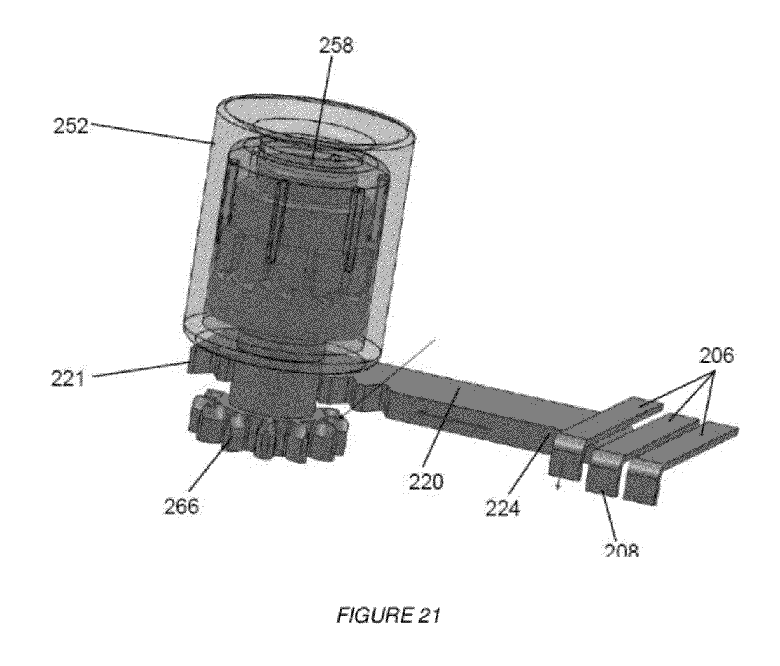

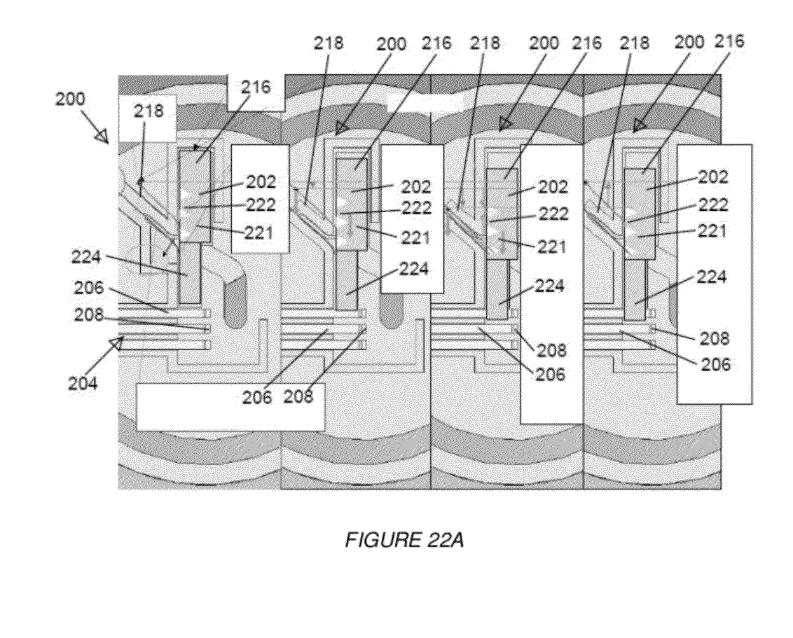

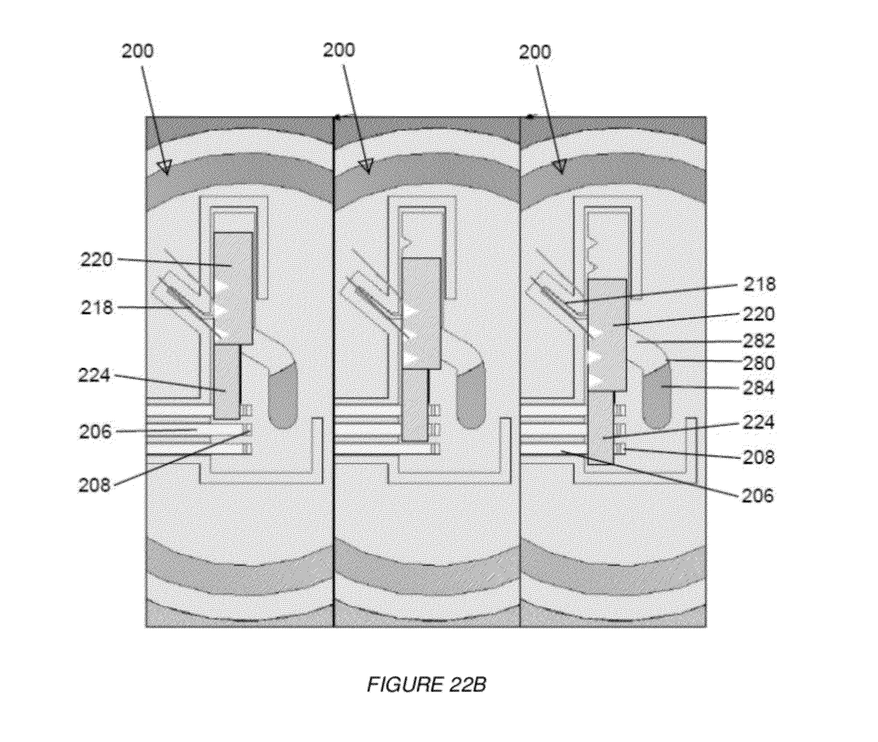

In another embodiment illustrated in FIGS. 15-21, the selection mechanism 202 is a push-button ratcheting mechanism 250 that functions much the same to progressively increment the rack-cam lifting dial spring fingers. The push button ratcheting mechanism 250 includes a housing 252 that can be connected to or otherwise integrated into the dial 16 (FIG. 14). The housing 252 has a plurality of internal ribs 254 generally parallel to the housing's longitudinal axis. The housing 252 has an internal area 256 that contains a button 258 having teeth or sloped lugs 260 with space between them sized to receive the ribs therebetween. In the illustrated embodiment shown in FIG. 16, the top of the button is slightly recessed within the housing to protect the button and to prevent in advertent activation of the button. Other embodiments can include the top of the button 258 projecting partially from the housing.

The button 258 receives and sets atop a cylindrical ratchet 262 that has radial ratchet teeth 264 that mate with the lugs 260 on the button 258. The bottom of the ratchet 262 is connected to a pinion 266, which is operatively connected to the rack portion 221 of the rack-cam device 220 so that rotation of the pinion causes axial motion of the rack-cam device 220. This axial motion causes the cam portion 224 to move relative to the spring finger assembly 204, so as to lift or lower the spring dialing fingers 206 relative to the combination disc 22. In the illustrated embodiment, the push-button ratchet mechanism 250 includes a retaining spring that engages the cylindrical ratchet 262 and a bottom flange of the housing 252 to help position the ratchet and the associated button 258 within the housing. In other embodiments, the spring may not be needed or included.

The button 258, the cylindrical ratchet 262 and the housing 252 with the ribs 254 are operatively coupled so that the button 258 can be depressed, which causes the lugs 260 to engage the ratchet teeth and cause the ratchet (and its associated pinion 266) to rotate the selected amount, thereby causing rack cam 220 to move (e.g., advance longitudinally) by a selected amount. Each time the button is depressed and the ratchet 262 and pinion 266 rotate, the cam portion 224 of the rack-cam device 220 moves enough to engage and lift the next spring dialing finger 206 of the spring finger assembly 204. In the illustrated embodiment, the mating lugs 260 of the button 258 and teeth 264 of the ratchet 262 are configured so that, upon depressing the button 258 approximately 0.030″, the ratchet 262 will be depressed enough to clear the internal ribs 254 (which act as an internal stop to restrict rotation of the ratchet) from the adjacent tooth 264 on the ratchet 262. As the button 258 is depressed, the ratchet 262 and the pinion 266 begin to turn and to advance the cam portion 244 of the rack-cam 220.

After the internal rib 254 has cleared the adjacent tooth 264, the button 258 is released and the rib 254 rides down a sloped surface of the ratchet's tooth, thereby continuing to rotate the ratchet 262 and pinion 266 and advancing the rack-cam 220 toward the spring finger assembly 204. In the illustrated embodiment, the button 258 includes twelve discrete rotation-generating lugs 260 that drive the ratchet 262. The button 258 is configured so that each depression or partial depression of the button will initiate an approximate thirty-degree rotation of the ratchet 262. Other embodiments can include a button with a different configuration, such as having a different number of teeth, thereby changing the amount of rotation of the ratchet with each depression of the button.

In the illustrated embodiment, the dialing operation can be reset by depressing the button 258 fully within the housing 252, so that the ratchet 262 and the pinion 266 are depressed until the pinion 266 is out of engagement with the rack portion 221 of the rack-cam 220. The rack-cam 220 can be connected to a spring or other biasing mechanism. When the pinion 266 is disengaged from the rack portion, the spring automatically returns the rack-cam 220 to a home position, such that the user can enter or reenter the lock's combination beginning with the first digit of the combination.

In operation, when user is entering the combination for the lock, the user rotates the dial 16 in either direction to the combination's first digit, and pushed the button 258. This pushing of the button 258 rotates the cylindrical ratchet 262 and the pinion 266 to move the cam portion 224 of the rack-cam 220 so as to lift the first spring dialing finger 206 to disengage it from the first combination disc. The user then rotates the dial either direction to the combination's second digit (either directly or after one or more rotations of the dial) and pushes the button 258 again. This second pushing of the button causes the cam portion to move and lift the second spring dial finger 206 under to disengage it from the second combination disc. This process is repeated for each of the digits of the combination, after which the combination discs properly orient the change hubs 106 so the lever 108 can rotate to release the shackle, as discussed above.

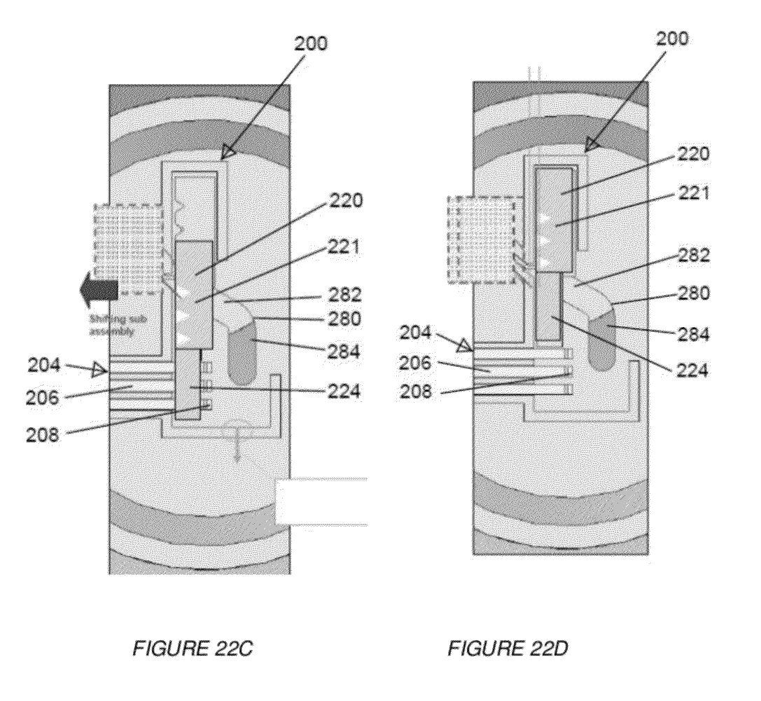

FIGS. 22A-22D provide a schematic and description of an embodiment of the progression of the rack-cam device 220 during the combination selection process and the reset process. Referring to FIG. 22A, the rack-cam device 220 is in a home or starting position wherein the cam portion 224 is adjacent to the three spring dialing fingers 206, which are in the lowered or un-lifted position and in engagement with the respective discs 22 (not shown). The button lever spring 218 is adjacent to the teeth 222 of the rack-portion, but the end of the button lever spring is not engaged in the rack teeth yet. The button lever spring 218, however, is positioned to extend into and engage the teeth 222 when the rack-cam device 220 moves from the home position. While the illustrated embodiment uses a button lever spring, other embodiments can use a spring-biased pawl or other moveable member to releasably engage and retain the rack-cam device 220 during the combination input process.

As the button 18 is activated (e.g., slid, pushed, etc.), the button causes the rack-cam device 220 to slide axially to the first position so the cam portion 224 engages and lifts the first spring dial finger 206, thereby disengaging it from the first combination disk. When the button 18 is activated a second time, shown in FIG. 24B, the button causes the rack-cam device 220 to slide axially from the first position to the second position so the cam portion 224 engages and lifts the second spring dial finger 206, thereby disengaging it from the second combination disk. During this movement from the first position to the second position, the rack portion moves the teeth 222 relative to the button lever spring 218 so the spring clicks into the next tooth on the ratchet portion so as to hold the rack-cam device 220 from moving back toward the first position.

When the button 18 is activated a third time, button causes the rack-cam device 220 to slide axially from the second position to the third position so the cam portion 224 engages and lifts the third spring dial finger 206, thereby disengaging it from the third combination disc 22, while the first and second spring dial fingers 206 remain disengaged from the first and second discs. During this movement from the second position to the third position, the rack portion moves the teeth 222 relative to the button lever spring 218 so the spring clicks into the next tooth on the ratchet portion so as to hold the rack-cam device 220 from moving back toward the second position. The dial can then be turned to the fourth digit of the combination, wherein all of the notches 110 in the change hubs 106 (FIG. 2) will be aligned with the lever 108 so the lever can pivot and allow the shackle to open.

In the embodiment illustrated in FIGS. 22C and 22D, the button 258 can be activated to reset or move the rack-cam device 220 from the third position back to the home position. In the illustrated embodiment, the button and the rack-cam device 220 is coupled to a J or S shaped path 280 that has a straight portion 282 along which the button 18 and/or rack-cam device 220 travels during the movement between the first, second, and third positions. The path 280 has a curved or lateral portion 284 along which the button and/or the rack-cam device 220 moves after the button moves past the third position. When the button 18 and/or the rack-cam device 220 moves along the lateral portion 284, the rack-cam device 220 is moved laterally away from the button lever spring 218, thereby disengaging the button lever spring 218 from the teeth 222 of the rack portion 221. After the button lever spring 218 is disengaged, the button 18 and/or the rack-cam device 220 can be released and returned back to the home position. In another embodiment, the button lever spring 218 can be configured to be moved laterally away from the button 18 and/or the rack-cam device 220, so as to disengage the button lever spring 218 from the rack portion 221 to allow the rack-cam device 220 to return to the home position. Once the rack-cam device 220 is in the home position, all of the spring dial fingers 206 will return to the lowered position in engagement with the combination discs 22, and the user can enter the combination beginning with the combinations first digit.

The following is a description of a sequence of operation of an embodiment of the lock assembly 10. While the description discusses the steps or features sequentially, it is noted that the steps and/or features may be performed in the listed sequence, but the operation may include the steps and/or features in another sequential order. Also, some embodiments may be configured for operation that includes fewer or additional steps and/or features in the listed order or in a different order. This is only one possible sequences of operation and is provided for purposes of explanation and clarity.

In one embodiment, the lock assembly unlocked and opened as follows: The dial 18 and/or rack-cam device 220 is cleared to the reset state or home position by fully stroking the slide button to the start or reset position. All three dial spring fingers 206 are extended. If the dial spring fingers 206 are not yet engaged with their respective discs 22 and in the notches 212, the dial 16 can be rotated 360+ degrees in either direction (CW, CCW) where upon each of the dial spring fingers 206 drop into combination disc notches 212 and engage the discs 22. The dial 16 is rotated either direction to the first combination digit. The dial can be rotated directly to the first combination digit, or the dial can be rotated through any number of revolutions before settling at the first combination digit. When dial 18 is positioned at the first combination digit, the first combination disc 22a and the mating change wheel 102 and hub 106 are aligned with the hub notch 110 below the lever fingers 112. The slide button 18 is actuated or slid toward the dial center, thereby “selecting” the first combination digit. Upon actuating the slide button 18, the rack-cam device 220 moves one position and lifts the first dial spring finger 206 from the first combination disc 22a, leaving the first combination disc disengaged from the dial and in an un-driven state.

The dial 16 is then rotated either direct to the next subsequent combination digit, such as to the second digit of the combination. Again, the dial can be rotated directly to the second combination digit, or the dial can be rotated through any number of revolutions before settling at the second combination. When dial 18 is positioned at the second combination digit, the second combination disc 22b, the second change wheel, and the first and second change hubs 106 aligned with the first and second hub notches 212 below the lever fingers 112. The slide button 18 is actuated or slid toward the dial center, thereby “selecting” the second combination digit. Upon activating the slide button, the rack-cam device 220 moves one additional position and lifts the second dial spring finger 206 from the second combination disc 22b, leaving the second combination disc disengaged from the dial and in an un-driven state.

The dial 16 is rotated either direction to the third combination digit directly or after any number of revolutions. In this position, the third combination disc 22c and the mating change wheel 102 and hub 106 are aligned with the hub notch 110 below the lever fingers 112. The slide button 18 is actuated or slid toward the dial center, and the rack-cam device 220 moves one additional position lifting the third dial spring finger 206 from the third combination disc 22c, leaving the third combination disc disengaged from the dial and in an un-driven state. During the above rotation of the dial and associated discs 22 and wheels, the friction spring 40 is always active holding the released combination discs 22 and change wheels 102 from accidentally rotating away from the selected positions. The dial is then rotated directly or after any number of revolutions in either direction to the forth combination digit. This action will direct drive the fourth combination disc 22d, so that the fourth combination disc 22d and the mating change wheel 102 and hub 106 are aligned so the hub notch 110 is below the lever fingers. In this position, all four change disc hubs 106 and their notches 110 are aligned under the lever fingers 112. The shackle 14 can then be lifted from the closed, locked position to the open, released position. Lifting of the shackle 14 rotates the lever assembly fingers 112 down into the hub notches 110, thereby allowing clearance to occur between the lever and shackle, so the shackle can be lifted and opened.

The shackle 14 can be closed at any time, upon which the shackle retaining clip will spin the combination discs 22 via the pivot spring mechanism 144, resulting in a scrambled lock that can only be opened upon re-entering the combination. The dial can be cleared or reset once again for the next operation by fully stroking the slide button.

The unlocking combination of the lock assembly 10 can be easily reset when the lock assembly is in the unlocked condition with the shackle open, as described above. The change cam 132 (FIG. 10) is slid (or rotated) to cam (translate) the change assembly shaft 130 and notched hubs 106 toward the front of the lock (i.e., toward the dial 16). The change wheels 102 are retained from moving by the change blocker 136 (FIG. 10D). The change hubs 106 are now disengaged from the mating change wheels 102. The lock assembly 10 is now taken through the opening procedure described above to a new and desired combination. This process reorients or re-references the change wheels 102 to the change hubs 106 setting a new combination. The change cam 132 is then returned to its original position. A combination change assembly spring 134 shifts the change shaft 130 and hubs 106 back into contact with the change wheels 102. The lock assembly 10 is then set with the new combination.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

I/We claim:

1. A resettable, combination dial lock assembly, comprising:
a housing;
a shackle moveable relative to the housing between a locked, closed position and an unlocked, open position;
a dial rotatably coupled to the housing, the dial having a face portion and a drive portion, the face portion or the housing having indicia thereon, a subset of the indicia defining a combination to allow the shackle to move from the locked, closed position to the unlocked, open position, the dial being rotatable to positions corresponding to each of the subset of the indicia comprising the combination;
a selector coupled to the dial, the selector being moveable to a select position;
a plurality of combination members connected to the drive portion of the dial and being rotatable upon rotation of the dial, each combination member being associated with a respective one of the subset of indicia comprising the combination, one combination member being disengageable from the drive portion upon moving the selector to the select position wherein the one combination member is stationary relative to the housing while at least a second combination member is rotatable with the dial independent of the stationary one combination member;
a plurality of rotary members coupled to the combination members wherein rotation of the combination members causes rotation of the rotary members, the rotary members being positionable in an unlocked configuration upon rotation of the dial independent of a direction of rotation to each indicia comprising the combination and upon activation of the selector at each indicia comprising the combination; and
a combination change mechanism movable between set and changes positions, the combination change mechanism activatable to manipulate the rotary members or the combination members when in the change position to change the combination from a first combination to a second combination different than the first combination.

2. The lock assembly of claim 1 wherein the combination members comprise a plurality of combination discs.

3. The lock assembly of claim 1 wherein the combination members comprise a stack of coaxially aligned combination discs.

4. The lock assembly of claim 1 wherein the combination members comprise a stack of nested combination discs.

5. The lock assembly of claim 1 wherein the combination members comprises a plurality of combination discs having first gear teeth thereon, and the rotary members comprise a plurality of change wheels having second gear teeth thereon that mate with the first gear teeth whereby rotation of the combination discs cause rotation of the change wheels.

6. The lock assembly of claim 1 wherein the combination members comprises a first stack of combination discs coaxially aligned on a first axis of rotation, and the rotary members comprising a second stack of change wheels coaxially aligned on a second axis of rotation spaced apart from the first axis of rotation.

7. The lock assembly of claim 1 wherein the rotary members combination members comprise a plurality of change wheels.

8. The lock assembly of claim 1 wherein the rotary members comprise a stack of coaxially aligned of change wheels.

9. The lock assembly of claim 1 wherein the rotary members comprise a plurality of change wheels and change hubs, wherein the change wheels are rotatable relative to the change hubs when the combination change mechanism is in the change position.

10. The lock assembly of claim 1 wherein the rotary members comprise a plurality of change wheels and change hubs, wherein the change wheels are rotatable with the change hubs when the combination change mechanism is in the set position and the change wheels are rotatable relative to the change hubs when the combination change mechanism is in the change position.

11. The lock assembly of claim 1 wherein the rotary members comprise a plurality of change wheels and change hubs, each change hub being associated with a respective one of the change wheels, each of the change hubs having a notch therein positioned relative to the change wheel and being aligned with notches in the other change hubs upon entry of the combination by activation of the selector at each indicia comprising the combination.

12. The lock assembly of claim 1, further comprising a lever assembly wherein the interconnecting the shackle and the rotary members, the lever assembly prevents the shackle from moving away from the locked, closed position prior the rotary members being positioned in the unlocked configuration.

13. The assembly of claim 1, further comprising a change selector connected to the combination change mechanism and movable to move the combination change mechanism between the set and change positions.

14. The assembly of claim 1 wherein the selector is connected to the dial and is slidable relative to the dial to the select position to disengage the combination member when the dial has been rotated for selection one of the indicia.

15. A resettable, combination dial lock assembly, comprising:
a housing;
a shackle moveable relative to the housing between a locked, closed position and an unlocked, open position;
a dial connected to the housing, the dial or the housing having indicia thereon, a subset of the indicia defining a combination to unlock the lock assembly, the dial being rotatable to positions corresponding to each of the subset of the indicia;
a selector coupled to the dial;
a plurality of combination members that rotate upon rotation of the dial, each combination member being associated with a respective one of the subset of indicia comprising the combination; and
a plurality of rotary members coupled to the combination members wherein rotation of the combination members causes rotation of the rotary members, the rotary members and combination members being configured to allow the dial to be rotated in any direction and independent of a number of rotations made by the dial for activation of the selector to select each indicia comprising the combination to unlock the lock assembly.

16. The lock assembly of claim 15, further comprising a combination change mechanism activatable to manipulate the rotary members or the combination members and to change the combination from a first combination to a second combination different than the first combination.

17. The assembly of claim 16, further comprising a change selector connected to the combination change mechanism and movable to move the combination change mechanism between the set and change positions.

18. The lock assembly of claim 16 wherein the rotary members comprise a plurality of change wheels and change hubs, wherein the change wheels are rotatable relative to the change hubs when the combination change mechanism is in the change position.

19. The lock assembly of claim 15 wherein the combination members comprises a first stack of combination discs aligned on a first axis of rotation, and the rotary members comprising a second stack of change wheels coaxially aligned on a second axis of rotation spaced apart from the first axis of rotation.

20. A method of unlocking a combination dial lock assembly, comprising:
engaging a dial of the combination dial lock assembly, the combination dial lock assembly having a housing, a shackle in a locked, closed position, indicia on the dial or the housing, and a selector, wherein shackle can be moved to an unlocked, open position upon selecting a subset of the indicia the defines a combination to unlock the assembly;
rotating the dial in a first direction relative to the housing to a first position corresponding to a first entry of the subset of the indicia;
selecting with the selector the first entry when the dial is in the first position;
rotating the dial relative to the housing to a second position corresponding to a second entry of the subset of the indicia;
selecting with the selector the second entry when the dial is in the second position, the dial being rotatable in either direction to define a second direction to the second entry independent of the first direction and being rotatable directly to the second entry or after one or more full revolutions of the dial relative to the housing to select the second entry;
rotating the dial relative to the housing to a third position corresponding to a third entry of the subset of the indicia;
selecting with the selector the third entry when the dial is in the third position, the dial being rotatable in either direction to the third entry independent of the first and second directions and being rotatable directly to the third entry or after one or more full revolutions of the dial relative to the housing to select the third entry; and
moving the shackle from the locked, closed position to the unlocked, open position after sequentially selecting the first, second and third entries.

21. The method of claim 20, wherein the dial is rotatable in either direction to define a third direction to the third entry, and further comprising:
rotating the dial relative to the housing to a fourth position corresponding to a fourth entry of the subset of the indicia;
selecting with the selector the fourth entry when the dial is in the fourth position, the dial being rotatable in either direction to the fourth entry independent of the first, second, and third directions and being rotatable directly to the fourth entry or after one or more full revolutions of the dial relative to the housing to select the fourth entry; and
moving the shackle from the locked, closed position to the unlocked, open position after sequentially selecting the first, second, third, and fourth entries.

22. The method of claim 20 wherein the first and second directions are the same direction.

23. The method of claim 20 wherein the combination is a first combination, and further comprising activating a change selector and changing the combination to a second combination different from the first combination.

24. The method of claim 20 wherein the subset of indicia is a first subset of indicia and the combination is a first combination, further comprising changing the combination to a second combination different from the first combination, wherein the second combination corresponds to a second subset of indicia different from the first subset of indicia.

25. A resettable, combination dial lock assembly, comprising:
a housing;
a resettable locking mechanism in the housing;
a shackle connected to the locking mechanism and being moveable relative to the housing between closed and open positions;
a dial rotatably coupled to locking mechanism, the dial having indicia thereon, a subset of the indicia defining a combination to unlock the locking mechanism, the dial being rotatable to positions corresponding to each of the indicia comprising the combination;
the locking mechanism being moveable from a locked configuration to an unlocked configuration upon rotation of the dial in either direction to the positions corresponding to the combination, in the locked configuration the locking mechanism retains the shackle in the closed position, in the unlocked configuration the locking mechanism is disengagable from the shackle and allows the shackle to move to the open position, the locking mechanism comprising:
a combination-disc assembly having a drive shaft connected to the dial and being rotatable with the dial, a plurality of combination discs coupled to the drive shaft and being engagable and rotatable with drive shaft upon rotation of the dial, each combination disc being associated with a respective one of the indicia comprising the combination, a first combination disc being movable relative to the drive shaft between engaged and disengaged positions, the first combination disc in the engaged position being rotatable with the dial and drive shaft, the first combination disc in the disengaged position being disengaged from a second combination disc or from the drive shaft and being restricted from rotation relative to the housing while the dial and the drive shaft are rotated;
a release lever in the housing and coupled to the shackle, the release lever having engaged and released positions, the release lever being in the engaged position when the shackle is in the closed position, the shackle being restricted from moving to the open position when the release lever is in the engaged position, the release lever being moveable to the release position upon entry of the combination by a user, wherein the release lever in the released position allows the shackle to move to the open position;
a combination change assembly comprising a plurality of rotary members in the housing, the rotary members being in engagement with the combination discs, wherein rotation of the combination discs causes rotation of the rotary members relative to the release lever, each rotary members being associated with a digit of the combination and each rotary members having a receiver alignable with a portion of the release lever when the associated digit of the combination is entered, the rotary members block the release lever from moving from the engaged position to the released position when one or more of the receivers are out of alignment with the portion of the release lever, and the rotary members allow the release lever to move from the engaged position to the released position when all of the receivers are in alignment with the portion of the release lever; and
a selection assembly coupled to the dial and to the combination disc assembly, the selection assembly being activatable to move at least one combination discs to the disengaged position when the dial has been moved to the digit of the combination associated with the at least one combination disc independent of a rotation direction of the dial or a number of rotations made by the dial to move to the digit.
